(19) United States
(12) Patent Application Publication
(10) Pub. No.: US 2004/0212592 A1
(43) Pub. Date: Oct. 28, 2004

(54) Light guiding device of an optical mouse

(75) Inventors: Ching-Pin Wang, Taipei City (TW); Li-Wen Tseng, Kaohsiung County (TW)

Correspondence Address: BACON & THOMAS, PLLC, 625 SLATERS LANE, FOURTH FLOOR, ALEXANDRIA, VA, 22314

(73) Assignee: Sunplus Technology Co., Ltd., Hsin-Chu (TW)

(21) Appl. No.: 10/687,633

(22) Filed: Oct. 20, 2003

(30) Foreign Application Priority Data
Apr. 23, 2003 (TW) 92206444

(51) Int. Cl. G09G 5/08

(52) U.S. Cl. 345/166

(57) ABSTRACT

A light guiding device of an optical mouse is disclosed. The light guiding device is implemented inside the optical mouse applied to an operating surface. The optical mouse has a light device to project an incident light. The light guiding device includes a first lens part facing to the light device for receiving the incident light. The incident light received is focused and then projected to a prism plane for total reflection such that the incident light is directed to a slope plane arranged obliquely towards the same direction as the prism plane. The incident light is further refracted slight downwardly into a cavity defined by a bottom of the light guiding device through the slope plane and finally projected on the operating surface through a bottom opening of the optical mouse.

### BACKGROUND OF THE INVENTION

1. Field of the Invention

The present invention relates to an improvement of a mouse mechanism and, more particularly, to a light guiding device of an optical mouse.

2. Description of Related Art

In typical optical mouse techniques, the operation principle essentially uses a light device (such as LEDs) to project an incident light to a use plane (for example, a desk surface or a mouse pad) and then determine optical mouse actions by judging an uneven or micro-scraggy surface of the use plane using reflecting light produced by the use plane.

With reference to FIGS. 1 and 2, a typical optical mouse 5 is shown. In FIGS. 1 and 2, because incident light I₂₁ produced by a light device 51 has to accurately pass through a bottom opening 50 of the optical mouse 5 to directly project on a reflective plane 6, the light device 51 needs a guiding device 52 to focus and direct the incident light I₂₁. As shown in FIGS. 1 and 2, the light device 51 projects the incident light I₂₁ to a first lens 521 of the light guiding device 52. Next, total reflection is produced respectively by a first prism plane 522 and a second prism plane 523. Then, the incident light I₂₁ after the two total reflections is projected on the reflective plane 6 through both a slope plane 524 and the bottom opening 50. The light guiding device 52 further includes a second lens 525 to focus and project reflecting light produced by the reflective plane 6.

However, in the cited light guiding device 52, incident light I₂₁ projected on the reflective plane 6 after the two total reflections can substantially cause light leakage and directly affect optical mouse operations. In addition, the light guiding device 52 is constrained by the advance direction of incident light I₂₁, which needs to be exactly perpendicular to the slope plane 524. If this condition is not met, i.e., deflection shown in an incident light I₂₂ or I₂₃ occurs, light shift is caused by an angle of reflection relative to the slope plane 524 and thus the incident light cannot be collectedly projected to the opening 50.

Another typical light guiding device 72 is shown in FIG. 3, wherein an incident light I₃₁ is incident perpendicularly to a first lens part 721, passing through a slope plane 723 after a total reflection by a prism plane 722 and finally projecting on a second lens part 724. The second lens part 724 then focuses and projects the reflecting light. However, the light guiding device 72 also meets the same problem as the device shown in FIG 1, i.e., large-angle light shift on deflection. That is, incident lights 132 and 133 are not incident exactly perpendicular to the slope plane 723. Therefore, the cited light guiding devices are not adapted for use.

Therefore, it is desirable to provide an improved light guiding device of an optical mouse to mitigate and/or obviate the aforementioned problems.

### SUMMARY OF THE INVENTION

An object of the present invention is to provide a light guiding device of an optical mouse, which applies total reflection once to an incident light and then projects it to a reflective plane, thereby reducing light leakage.

Another object of the present invention is to provide a light guiding device of an optical mouse, which downwardly refracts incident light at different advance angles in order to direct it to the reflective plane, thereby profiting mass-production and increasing mouse durability.

To achieve the objects, the light guiding device of an optical mouse of the present invention is implemented inside the optical mouse applied to an operating surface. The optical mouse has a light device to project an incident light. The light guiding device includes a bottom, a first lens part, a prism plane and a slope plane. The bottom defines a cavity. The first lens part is disposed facing to the light device to receive and focus the incident light and project it after being focused. The prism plane is disposed obliquely towards the first lens part to totally reflect the incident light focused by the first lens part. The slope plane is arranged obliquely substantially towards the same direction as the prism plane in order to refract the incident light totally reflected by the prism plane light downwardly in order to direct it into the cavity.

The cited incident light forms an included angle of 90 degrees relative to the operating surface and is focused by the first lens part to form an included angle of 45 degrees relative to the prism plane. Therefore, the incident light after being totally reflected is parallel to the operating surface. The incident light in parallel to the operating surface is directed by the slope plane arranged obliquely towards the same direction as the prism plane, thereby further downwardly refracting and directing the incident light into the cavity.

Other objects, advantages, and novel features of the invention will become more apparent from the following detailed description when taken in conjunction with the accompanying drawings.

### BRIEF DESCRIPTION OF THE DRAWINGS

FIG. 1 is a cross-section of a typical optical mouse interior;

FIG. 2 is a cross-section of a light guiding device of FIG. 1;

FIG. 3 is a cross-section of another light guiding device of FIG. 1;

FIG. 4 is a cross-section of an optical mouse interior according to the invention; and

FIG. 5 is a cross-section of a light guiding device of FIG. 4 according to the invention.

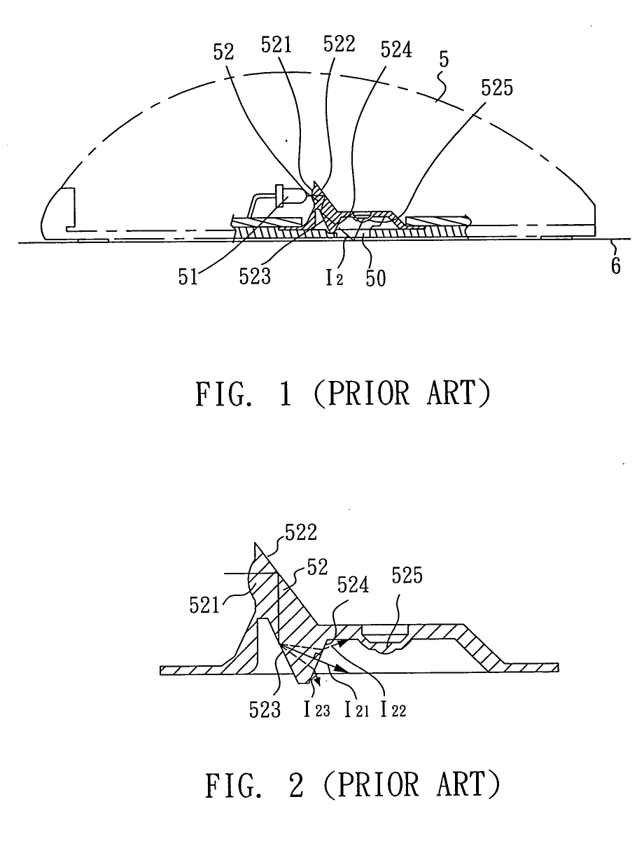

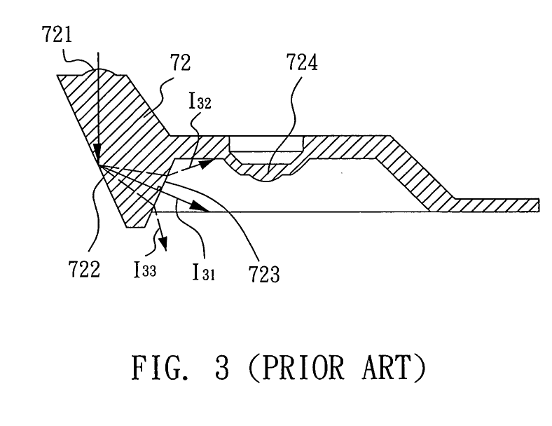

### DETAILED DESCRIPTION OF THE PREFERRED EMBODIMENT

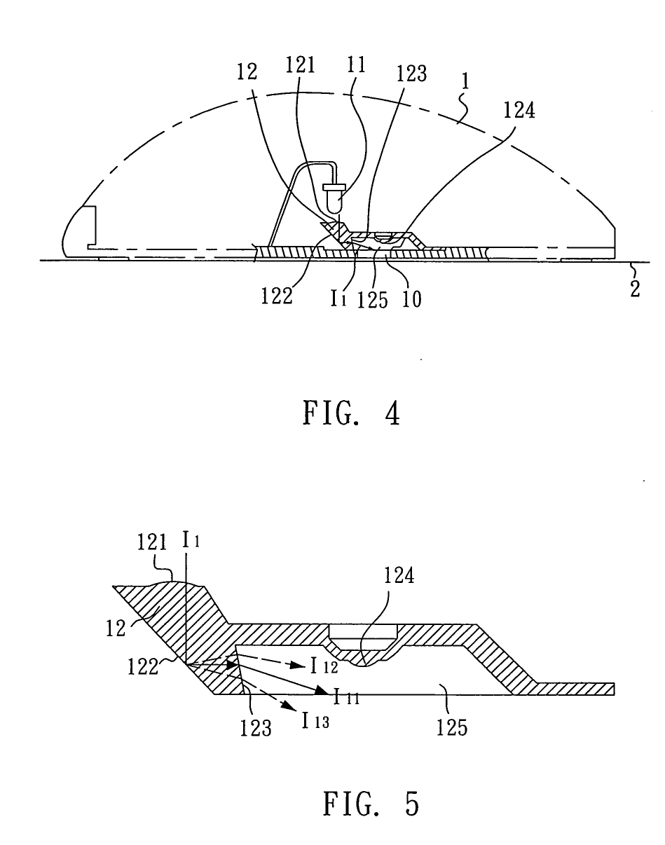

With reference to FIGS. 4 and 5, an embodiment of the invention is shown. FIG. 4 shows an optical mouse 1 with a bottom opening 10. The optical mouse 1 internally includes a light device 11 and a light guiding device 12. The light device 11 is preferably a light emitting diode (LED) die or the like. The light device 11 emits an incident light source I₁. The top plane of the light guiding device 12 is protruded to form a first lens part 121 with one end having an oblique prism plane. The bottom of the light guiding device 12 defines a cavity 125 to provide light reflection on internal walls of the cavity 125. The cavity 125 has a slope plane internally adjacent to the prism plane 122. The slope plane is disposed obliquely slightly towards a reflective plane and is inclined approximately towards the same direction as the prism plane 122.

As shown in FIGS. 4 and 5, because the light device 11 projects the incident light sources I₁ along a direction vertical to the reflective plane 2 while the first lens part 121 of the light guiding device 12 is disposed facing to the light device 11, the incident light I₁ is projected just into the first lens part 121. The prism plane 122 is tilted to the first lens part 121. In this case, the prism plane 122 forms an included angle of 45 degrees relative to the first lens part 121 (or the reflective plane 2). The incident light I₁ after vertical incidence and focus forms a 45-degree angle of incidence relative to the first lens part 121 and an angle of reflection derived from the law of reflection is 45 degrees to indicate that the incident light I₁ changes the advance direction with respect to the reflective plane 2 from vertical to parallel after a 90° total reflection produced by contacting on the prism plane 122. Finally, the incident light I₁ is slightly and downwardly refracted by contacting on the slope plane I₂₃ in order to produce an incident light I₁₁ and direct it into the cavity 125.

It is noted that, in general practice, parts of the optical mechanism inside the optical mouse 1 may emit an incident light I₁ at a slight inclination, i.e., not completely vertical to the reflective plane 2, due to collision or poor assembling. Thus, the incident light I₁ is not completely parallel with the reflective plane 2 after the total reflection in the prior art. However, in this embodiment, the slope plane I₂₃ is disposed slightly obliquely towards a reflective plane and is inclined approximately towards the same direction as the prism plane 122. Thus, in accordance with the law of reflection, the incident light I₁ can be lightly and downwardly refracted by the slope plane I₂₃ to form, for example, an incident light I₁₁, I₁₂ or I₁₃ to project into the cavity 125. Next, the incident light I₁₁, I₁₂ or I₁₃ from the cavity passes through the opening 10 in the bottom of the optical mouse 1 to project on the reflective plane 2.

Finally, the second lens part 124 above the cavity 125 of the light guiding device 12 focuses reflecting light produced by the reflective plane 6 to propagate to a photosensor (not shown) assembled above the second lens part 124 such that the photosensor can determine the features of the reflective plane 2 based on the reflecting light propagated by the second lens part 124 and accordingly control the mouse 1's operations.

According to the cited embodiment, the inventive light guiding device of an optical mouse essentially guides an incident light that is vertically incident to a reflective plane after one total reflection, thereby reducing the light leakage caused by two total reflections in the prior art and further increasing the performance of optical mice. In addition, the inventive light guiding device of an optical mouse adds a slope plane to lightly and downwardly refract the incident light so as to eliminate the limits that the advance direction of the incident light has to parallel that of the reflective plane and the incident light has to be completely vertical to the slope plane, thereby largely reducing closed circuit malfunction caused by collision and poor assembling, increasing the durability and profiting mass-production.

Although the present invention has been explained in relation to its preferred embodiment, it is to be understood that many other possible modifications and variations can be made without departing from the spirit and scope of the invention as hereinafter claimed.

What is claimed is:

1. A light guiding device of an optical mouse, implemented inside the optical mouse applied to an operating surface, the optical mouse having a light device to project an incident light, the light guiding device comprising:
a bottom, to define a cavity; and
a first lens part disposed facing to the light device, to receive the incident light projected by the light device and focus the incident light to project;
a prism plane disposed obliquely towards the first lens part to totally reflect the incident light focused by the first lens part; and
a slope plane arranged obliquely substantially towards the same direction as the prism plane, to slightly and downwardly refract the incident light after a total reflection in order to guide the incident light totally reflected by the prism plane into the cavity.

2. The light guiding device as claimed in claim 1, wherein the incident light after being focused by the first lens part has an included angle of 45 degrees relative to the prism plane.

3. The light guiding device as claimed in claim 2, wherein the incident light after the total reflection is parallel with the operating surface.

4. The light guiding device as claimed in claim 1, wherein the incident light projected by the light device has an included angle of 90 degrees relative to the operating surface.

5. The light guiding device as claimed in claim 1, wherein the optical mouse has a bottom opening facing directly to a cavity opening formed in the cavity's bottom such that the bottom opening faces directly to the cavity opening formed in the cavity's bottom when the light guiding device is implemented in the optical mouse, so that the incident light in the cavity is projected on the operating surface through the bottom opening and the cavity opening.

6. The light guiding device as claimed in claim 5, further comprising a second lens part disposed in the cavity, to focus reflecting light formed by projecting on the operating surface and project the focused reflecting light.

7. The light guiding device as claimed in claim 1, wherein the light device is a light emitting diode (LED) die.
